(19) United States
(12) Patent Application Publication
(10) Pub. No.: US 2019/0034248 A1
(43) Pub. Date: Jan. 31, 2019

(54) ALERTING DEVICE FOR ANTICIPATING TREND REVERSAL IN THE EVOLUTION OF A QUANTITY

(71) Applicant: Wally Tzara, Paris (FR)

(72) Inventor: Wally Tzara, Paris (FR)

(21) Appl. No.: 16/069,249

(22) PCT Filed: Jan. 13, 2017
(86) PCT No.: PCT/IB2017/050196

§ 371 Date: Jul. 11, 2018

(30) Foreign Application Priority Data
Jan. 15, 2016 (FR) 1670006

(51) Int. Cl. G06F 9/54; G06Q 40/04; G08B 21/18

(52) U.S. Cl. CPC G06F 9/542; G08B 21/182; G06Q 40/04

(57) ABSTRACT

A device (DT) intended to warn the user (U) of a trend reversal to come in the evolution of a quantity (G) whose events comprise each at least a value V and a corresponding instant T. Its processing module (PM) 5 compares value V at an instant with a chosen value Vc, and if value V does not cross value Vc, compares value V assumed at the following instant with value Vc, if value V crosses value Vc, compares value V assumed at the following instant with a chosen value Va, and if value V does not cross value Va, compares value V assumed at the following instant with value Va, and if 10 value V crosses value Va, triggers an alert (A). The device also comprises graphical management means for the said values.

The invention relates to real-time alerting devices for processing numerical data events, intended to be implemented in a computer system comprising at least one microprocessor capable of processing the said data event, such as a personal computer.

“Event” should be understood here as a set comprising at least one value assumed by a quantity varying over time at a given instant (time) and the said instant.

### TECHNICAL FIELD

The invention relates to all kinds of quantities susceptible of varying over time. Such an event can be, for example, the detection or the recording of a quantity (physical or other), such as the atmospheric pressure at a given location, the average temperature of the Earth, the number of cosmic particles detected, or the price of a barrel of crude oil at a given instant. Depending on the nature of the considered quantity, an event can be comprised of only one value and an instant, or, for example, a primary value and a secondary value, such as a value and its dispersion, respectively, or such as the value and the weighting value (or weighting coefficient) associated to the value from the quantity, and an instant. The average water temperature every minute and its dispersion during that time interval allow constituting a chronological set of events, each event being made up of a primary value, a secondary value and an instant. 14 degrees Celsius plus or minus 2 tenths of a degree at 08:12 is an example of such an event. The number of shares exchanged at a given price and the time of the transaction is an example of an event made up of a value, an associated weighting value (here, the number of shares), and an instant, such as 250 shares of X exchanged at €13.10 at 14:28:17.

### BACKGROUND ART

The use of alerts allows warning a user, a machine, or a computerized system in the case of the crossing of fixed values (or threshold values). For example, if the temperature goes below 5° C., an order is given to a boiler burner or a pump. Such alerts are usually simple threshold crossing alerts. Finance is a field which uses many types of alerts (called alerts and stock market orders). However, these alerts do not rely on any conditionality applied to the quantity itself. For example, if the price of index X reaches a given value, then, if the price of index Y reaches another given value, an alert is triggered. Such an alert can be said to be conditional, but one can see that the condition does not apply to the quantity responsible for the alert itself.

### Technical Problem

Such alerts are useful but do not allow spotting or, better, anticipating trend reversals in the evolution of a quantity over time. This is all the more obvious as the conditionality is independent of the quantity. Being able to anticipate trends in the evolution of a quantity thanks to an alerting device that requires inexpensive computer resources would be very useful. The current devices intended for anticipating trend reversals in the evolution of a quantity rely for the most part on mathematical modeling of the considered quantity, which makes them complicated, not very reliable, and costly in computer resources.

### Solution to Problem

The invention proposes to this end an alerting device for processing data events allowing the anticipation of trend reversals in the evolution of a quantity susceptible of varying over time. Moreover, the proposed invention is very reliable and economical in computing resources. The invention proposes also a graphical management of the alert. Each event must comprise at least the value assumed by a quantity varying over time at a given instant and the said instant. Each event from the considered quantity can also comprise a primary value, a secondary value and an instant. We should note this second type of event is usually derived from the first type of event (value at a given instant and said instant), by grouping first type events and spacing out timestamps.

### DISCLOSURE OF THE INVENTION

The present alerting device comprises processing means capable of, starting from an initial instant T0 corresponding to value V0 from a quantity,

comparing value V from the said quantity with a chosen value Vc, and if value V does not cross value Vc (by “crossing”, one should understand the action consisting in value V (variable V) reaching or going beyond a threshold, above or below it, which can be mathematically expressed here, for example, by condition C (V−Vc)*(Vc−V0)≥0), starting over and comparing value V assumed by the quantity at the following instant with value Vc, and if value V crosses value Vc,

comparing value V at the following instant with a chosen value Va, and if value V does not cross value Va (that is to say, for example, (Va−V)*(Vc−V0)<0), starting over and comparing value V at the following instant with value Va, and if value V crosses value Va (that is to say, for example, (Va−V)*(Vc−V0)≥0 (condition A)), and

triggering an alert.

In what precedes and what follows, V represents any value assumed by the considered quantity at any corresponding instant T.

We will refer to the series of processing steps listed above as “algorithm 1”. In what follows, we will call “trend reversal alert”, the setup of an alert on a quantity according to the invention.

Moreover, the alerting device ensures beforehand that values Vc and Va are chosen in such a way that they are not identical, that they are different from initial value V0, and that values V0 and Va are “on the same side” in relation to value Vc (that is to say, chosen value Va does not itself cross chosen value Vc), which can be expressed mathematically by (Vc−V0)*(Vc−Va)>0. We will call this preliminary condition “condition 1”.

The alerting device according to the invention can comprise other features taken separately or in combination (which we will call “additional”, when referring to them in what follows), and in particular:
processing means allowing the user to deactivate the trend reversal alert at any time posterior to the initial instant T0, as long as the alert has not been triggered;
processing means allowing deactivation of the trend reversal alert automatically if the alert did not get triggered before a chosen time posterior to instant T0;
processing means allowing deactivation of the trend reversal alert automatically after the alert got triggered;
processing means allowing deactivation of the trend reversal alert if (threshold) value Va was crossed before value Vc was crossed;
the addition of a chosen value Vd, provided (Vd−Vc)*(Vc−Va)>0 (condition 2), allowing deactivation of the trend reversal alert if value V crosses value Vd at a posterior (or equal) instant to the instant of the crossing of value Vc by value V, which can be expressed mathematically by, for example, (V−Vd)*(Vd−V0)≥0 (condition D);
the use of a secondary value in the comparisons performed by the processing means such that either the primary value or the secondary value is used for each comparison, or the sum or the difference of the primary value and the secondary value is used for each comparison;
the association of an action to the alert;
processing means allowing modifying crossing thresholds Vc, Va or Vd, as long as it has not been crossed;
processing means allowing graphical management of values Vc, Va and Vd with the use of lines representing the said values;
memorization means responsible for storing the values V1, V2 and V3 of the crossing of the respective thresholds Vc, Va and Vd by the said quantity, their respective instants T1, T2 and T3, and the said thresholds.

The invention proposes also a storage medium, intended to be connected to computer equipment, and storing at least part of the data processing device of the type presented above and implemented as computer program(s).

### BRIEF DESCRIPTION OF DRAWINGS

Other characteristics and advantages of the invention will become apparent upon examination of the detailed description that follows and of the attached drawings, wherein:

FIG. 1 shows in very schematic and functional form an example of an embodiment of a data processing device according to the invention implanted in a computer system;

FIG. 2 shows in schematic and synthetic form the functioning of a threshold crossing alert;

FIGS. 3B, 4A and 4B show in schematic and symbolic form the functioning of the proposed alerting device;

FIG. 5 shows in schematic and functional form the basic characteristics of the proposed alerting device, as well as a certain number of additional features;

FIGS. 6A, 6B, 7A and 7B show in schematic and symbolic form the functioning of the proposed alerting device in the case where it comprises a threshold Vd to deactivate the trend reversal alert;

FIG. 8 shows in schematic and functional form the functioning of the proposed alerting device in the case where it comprises a threshold Vd to deactivate the trend reversal alert;

FIGS. 9A, 9B, 10A and 10B show in schematic and symbolic form the functioning of the additional feature of the alerting device, which allows modifying thresholds Vc, Va and Vd;

FIGS. 11A and 11B show charts of a real example of a trend reversal alert before and after the triggering of the alert.

The attached drawings may serve not only to complement the description of the invention, but also to help define it, where necessary.

### DESCRIPTION OF EMBODIMENTS

The aim of the invention is to allow warning a user or informing another device, such as a remote computer system connected to the proposed alerting device, of a trend reversal to come in the evolution of a quantity susceptible of varying over time. The term “trend reversal alert” has been chosen here based on the ability of the alerting device to warn the user or a machine of a future change of trend in the evolution of a quantity.

One should note that despite the fact that the invention works autonomously whatever the considered quantity susceptible of varying over time, the selection of the crossing thresholds Vc, Va and Vd is to be made by the user or possibly by a machine (of an artificial intelligence type). To this effect, the use of a topological network constructed from numerical values from the considered quantity, such as proposed in the U.S. Pat. No. 8,301,675 (“Computer system for predicting the evolution of a chronological set of numerical values”), for example, allows the user, trained in the art, to choose the crossing thresholds Vc and Va, and optionally Vd if the user wishes. We will therefore not discuss in what follows the way to choose the crossing thresholds Vc, Va and Vd, which is not relevant to the present invention.

Regarding value V0, the value assumed by the quantity at instant T0, it should be understood that it does not correspond to the choice of a value as a result of any expertise of the user, but corresponds simply to the value corresponding to the last known instant prior to the starting instant arbitrarily chosen by a user when he decides to place such a trend reversal alert on the considered quantity.

In what follows, we will consider, in a non-limiting way, that the considered quantity in each illustrative example, except the last one, is represented by a series of discrete events, each one made of a value assumed by the quantity at a given instant and the said instant. But, the invention also deals with any type of quantity susceptible of varying over time, for which each event is made of the triplet primary value, secondary value and instant, as will be briefly illustrated last. We will also consider for the sake of concision that “user” can also refer to a machine.

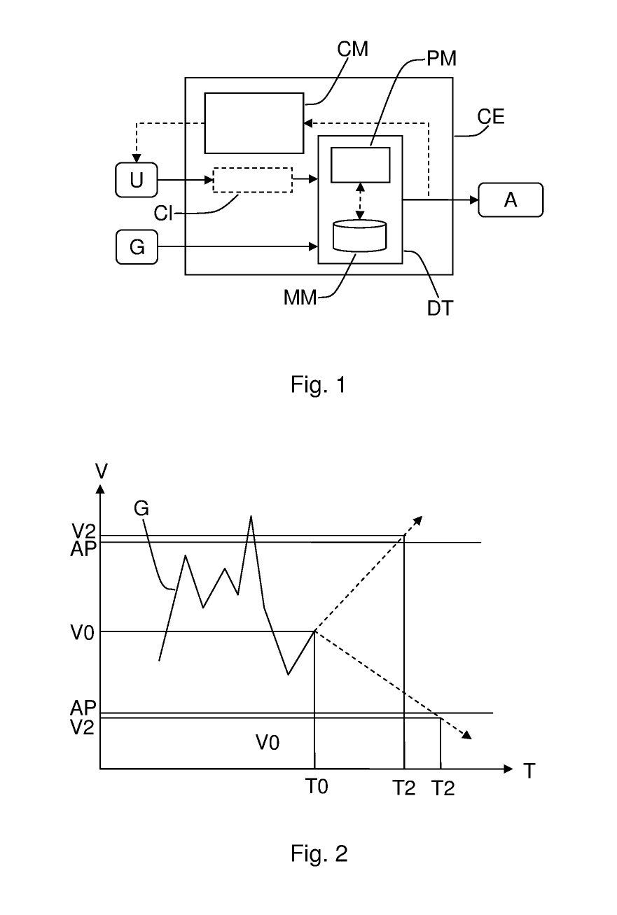

We will refer first to FIG. 1 to present an example of an implementation of the data processing device DT according to the invention. Such a device DT is intended to be installed in a computer system CE comprising at least one microprocessor capable of processing data, a storage medium and a man-machine interface (computer keyboard, mouse, monitor (graphical display unit), and the like). This computer system CE can be, for example, a personal computer (possibly a laptop), a workstation or a server.

This processing device DT is preferably made in the form of program modules (“software”), but can also be made in the form of electronic circuits (or “hardware”), or a combination of the two. When the device DT is made in the form of program modules, it can be, for example, installed in a computer system CE via downloading from a server or through loading from a storage medium, such as an optical disc, like a DVD, a USB key or an external disk drive, like an SSD drive, on which it is stored.

The processing device DT comprises at least a processing module PM responsible for processing numerical data events from the quantity, such as the atmosphere pressure at a given location every hour. For convenience's sake, we will say that the processing module PM possesses “processing means” and that PM refers equally to the processing module or the processing means. When the processing device DT is made in the form of program modules, its processing module PM is loaded in the computer system CE in order to be utilized by its processor or processors.

The numerical data (events from the considered quantity) G is, for example, loaded in real-time in the memory associated to the processor (possibly processors), both belonging to the processing module PM of the computer system CE (as represented in the non-limiting example in FIG. 1), after the said data has been received through a connection via a communication network, such as the Internet or Intranet, by the computer system CE.

The different crossing threshold values are input by the user U, for example, thanks to a user interface CI comprising, for example, of a keyboard and a mouse. The processing module PM performs the data processing operations allowing the triggering of an alert A with a warning (for example, a sound or visual warning) or not (as represented by the dashed arrow) to the user U thanks to an output device CM, such as a display unit, like an LCD monitor. It should be noted that the alert A can be transmitted to the computer system CE itself or to another remote computer system, such as a server, through a connection via a communication network (Internet, Intranet or other).

The device DT can comprise memorization means MM responsible for storing the crossing values and their respective instants in order, for example, to be reviewed by the user U or displayed on a monitor (output device CM).

As mentioned earlier, the user U can be a machine (of an artificial intelligence type), in which case, the said values are input directly, without the use of a user interface CI. The optional nature of the user interface CI is represented by a dashed line (as used to represent the other optional elements in the diagram).

It should be noted that the numerical data and the crossing thresholds can be displayed on a monitor CM of a computer system in the form of a chart representing the evolution of the quantity over time, where the time is the abscissa, for example, and the crossing thresholds are represented by horizontal lines. Such a graphical representation of the quantity and of the thresholds allows trend reversal alerts to be easily managed graphically, as will be described further on.

FIG. 2 presents a symbolic example of a crossing alert where the values assumed by the considered quantity G are plotted on the vertical axis (ordinate) V and the instants of the said values are plotted on the x-axis (abscissa) T. The value of the crossing threshold AP is represented by a horizontal line. To reduce the number of figures, the crossing threshold AP has been put twice on the chart, once above and once below value V0 assumed by the quantity G at instant T0. V2 represents the value assumed by quantity G at instant T2 immediately following the crossing of the threshold AP. This type of universally used alerting device allows warning a user or a machine in the case of a crossing, above or below, of a chosen threshold, but does not allow anticipating a future trend reversal in the evolution of a quantity, unlike the proposed alerting device described with the help of the following figures given as non-limiting examples.

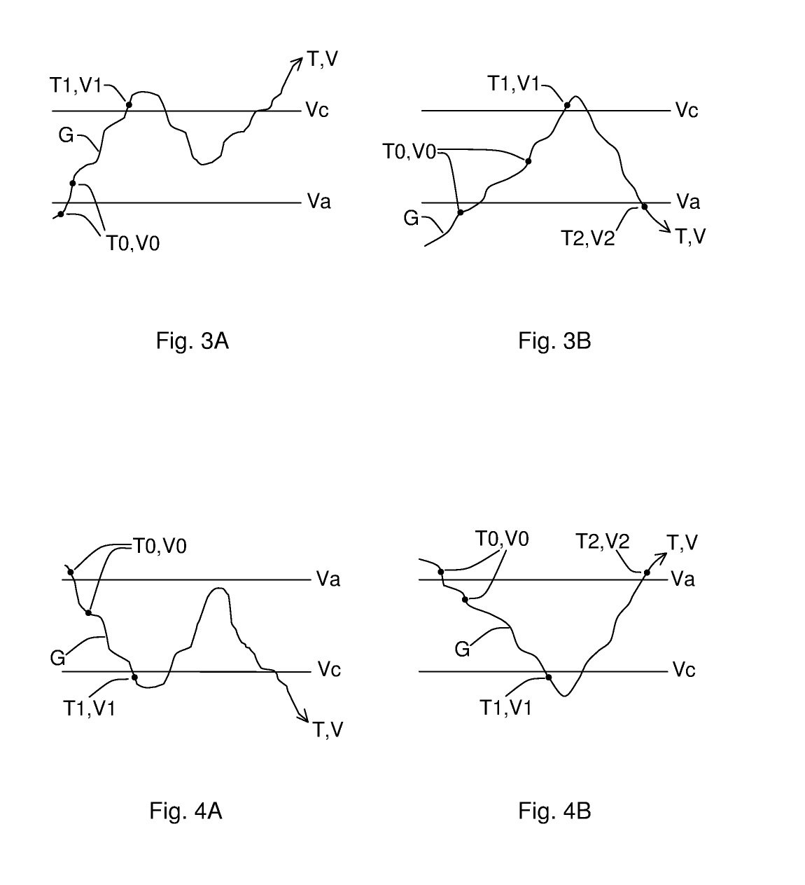

In each one of FIGS. 3A to 4B, 6A to 7B, and 9A to 10 ft value V0 of corresponding instant T0 is represented twice in order to cover all the cases while reducing the number of figures, without hindering their understanding. In these figures, the events from the quantity G are represented by a solid curve constructed by joining each discrete event to the next one with a line segment. The first step in each example consists in the user U choosing the thresholds Vc and Va, represented by horizontal solid lines in FIGS. 3A to 4B, 6A to 7B, and 9A to 10B.

Algorithm 1 and condition 1 are illustrated in FIGS. 3A to 4B. In these four figures, the event values are plotted on the y-axis and their corresponding instants on the x-axis.

Thanks to a (additional) feature of the alerting device, depending on the instant the user chooses to input the thresholds Vc or Va in the said device, at a time posterior to instant T0, condition 1 is applied by the said device. Condition 1 can be realized, for example, in one of the forms listed below. The processing means of the alerting device:
forbid the user U from inputting a chosen value Va, after value Vc has been input, that does not meet condition 1;
forbid the user U from inputting a chosen value Vc, after value Va has been input, that does not meet condition 1;
warn the user U that such chosen value Va, input after value Vc, or such chosen value Vc, input after value Va, is forbidden by applying condition 1.

In other words, if values V0, Vc and Va are plotted on the y-axis, the alerting device ensures that if value Vc is input first, then, value Va is allowed only on the side containing value V0 in relation to value Vc, and if value Va is input first, then, value Vc is not allowed between values V0 and Va.

Note that it is more logical to input value Vc first because it is the crossing of value Vc by value V in algorithm 1 that allows moving to the next comparison, that is, with value Va.

In FIGS. 3A and 3B, one can see that values Va and V0 are on the same side in relation to value Vc, that is, in the same half-plane (which we will name (V0, Va, Vc)) defined by the horizontal line of ordinate Vc. Thus, condition 1 is met. In FIG. 3A, the crossing of value Vc by value V has taken place (at instant T1 of corresponding value V1 in the example), but the crossing of value Va by value V has not (or net yet) taken place, and therefore, alert A has not (or not yet) been triggered. In FIG. 3B, on the contrary, value Va has been crossed (at instant T2 of corresponding value V2 in the example) after value Vc was itself crossed, which, according to algorithm 1, triggers alert A.

FIGS. 4A and 4B meet condition 1 and illustrate algorithm 1 also. FIGS. 4A and 4B are actually vertically flipped in relation to FIGS. 3A and 3B, respectively. They allow understanding algorithm 1 and condition 1 in a visual way when value Vc is “below” value V0, but it is obvious that these two examples are equivalent to the two previous ones, since it would suffice to draw the y-axis in the opposite direction to end up with them. But since a change in the graphical representation does not change the nature of a phenomenon, we will not use FIGS. 4A and 4B to describe again algorithm 1 and condition 1 in order not to repeat ourselves.

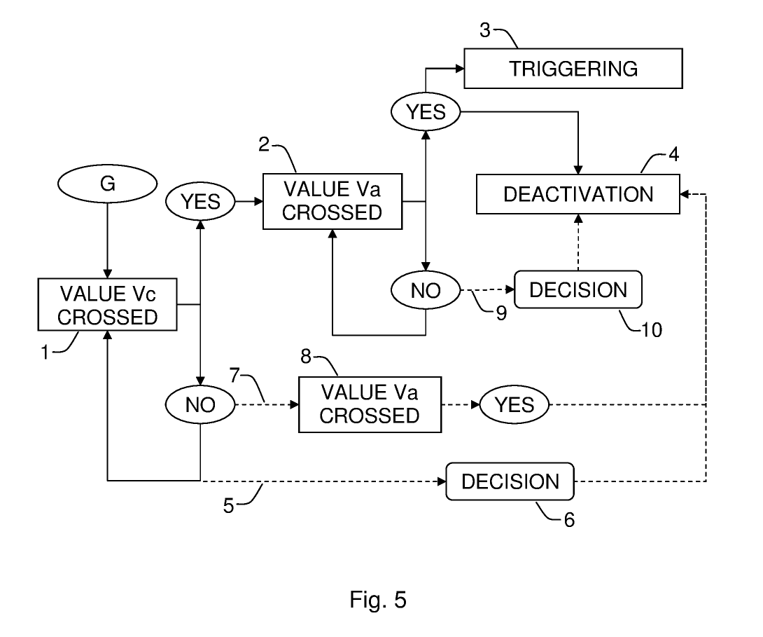

In FIG. 5, steps or options are numbered from 1 to 10. It represents the minimal functional diagram of a part of the alerting device comprising algorithm 1 and other (additional) features, which can be taken separately or in combination. Step 1 consists in comparing value V assumed by quantity G at a given instant with a chosen value Vc. If value V does not cross value Vc (in other words, if value V remains in the half-plane (V0, Va, Vc), which can be expressed mathematically, for example, by (V−Vc)*(Vc−V0)<0), one then goes back to step 1. If, on the contrary, value V crosses value Vc (condition C), one then goes to step 2. Step 2 consists in comparing value V assumed at the following instant with a chosen value Va. If value V does not cross value Va (in other words, if (Va−V)*(Vc−V0)<0), one then goes back to step 2. If, on the contrary, value V crosses value Va (condition A), one then goes to steps 3 and 4, which are respectively the triggering alert A and the simultaneous deactivation of the trend reversal alert. When alert A is triggered, the processing device can also order an action, such as warning the user U or informing another remote computer system. Warning the user U can consist, for example, in displaying a visual message on the output device CM or sending a sound to an audio output device belonging to the computer system CE.

The order to execute an action, given by the processing module PM when the alert A is triggered, can, for example, serve to place a stock market order, such as the buying or the selling of a financial instrument. When the alerting device is used for that purpose, the deactivation of the trend reversal alert is equivalent to cancelling the stock market order.

Among the other (additional) features is option 5 (represented by a dashed arrow), which allows the user U to deactivate freely the trend reversal alert (step 6 “decision”) at any time, as long as value Vc has not been crossed. Such a possibility exists in option 9 (represented also by a dashed arrow), allowing the user U to deactivate the trend reversal alert (step 10 “decision”) at any time, as long as value Va has not been crossed. As mentioned before, it is possible that steps 6 and 10 correspond instead or also to processing means allowing deactivation of the trend reversal alert automatically, if it has not been triggered before a chosen time posterior to T0. User U could have chosen, for example, when the trend reversal alert was set, a duration beyond which the trend reversal alert is deactivated by the alerting device.

The alerting device can comprise (dashed arrow of option 7) (additional) processing means allowing deactivation of the trend reversal alert if value Va is crossed before value Vc has been crossed (step 8). Note that the alerting device allows step 8 only when chosen values Vc and Va are such that value V0 is between values Vc and Va, which can be expressed mathematically, for example, by (V0−Va)*(Vc−Va)>0 (condition 6).

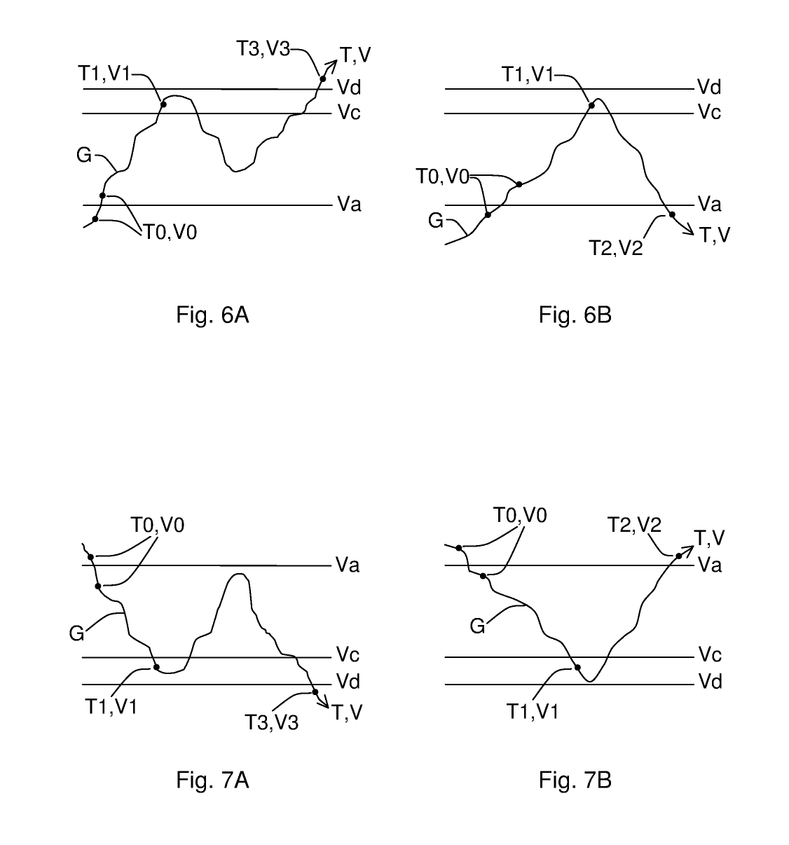

FIGS. 6A and 6B illustrate a (additional) feature, which allows, thanks to the addition of a chosen value Vd, deactivating the trend reversal alert if the value V crosses the value Vd at an instant posterior (or equal) to the crossing of value Vc by value V. The condition of validity (condition 2) of value Vd, previously mentioned, is (Vd−Vc)*(Vc−Va)>0. This condition can be expressed in natural language by saying that value Vc must be situated between values Va and Vd. One can see on these two figures that this condition is met.

In the example presented in FIG. 6A, the trend reversal alert was deactivated because value V crossed value Vd (at instant T3 of corresponding value V3 in the example) without value V having previously crossed value Va. The crossing condition can be expressed as (V−Vd)*(Vd−V0)≥0 (condition D). Note that the crossing of value Vd by value V is necessarily preceded by a crossing of value Vc (at instant T1 of corresponding value V1 in the example) by value V since (Vd−Vc)*(Vc−Va)>0 (condition 2).

Condition 2 of the (additional) feature illustrated by FIGS. 6A and 6B can be realized, for example, in one of the forms listed below. The processing means of the alerting device:
forbid the user U from inputting a chosen value Vd, after value Vc has been input and without value Va having been input, that does not meet the condition (Vd−Vc)*(Vc−V0)>0 (derived from condition 2);
forbid the user U from inputting a chosen value Vd, after values Vc and Va have been input, that does not meet condition 2;
warn the user U that such chosen value Vd is forbidden by applying condition 2.

FIGS. 7A and 7B also illustrate the previous (additional) feature. These two figures are again vertically flipped in relation to FIGS. 6A and 6B, respectively. They allow understanding the said feature and condition 2 in a visual way when value Vd is “below”, but these two examples are equivalent to the previous ones by reflection symmetry around the x-axis (symbolic and not represented). For this reason, FIGS. 7A and 7B will not be described further.

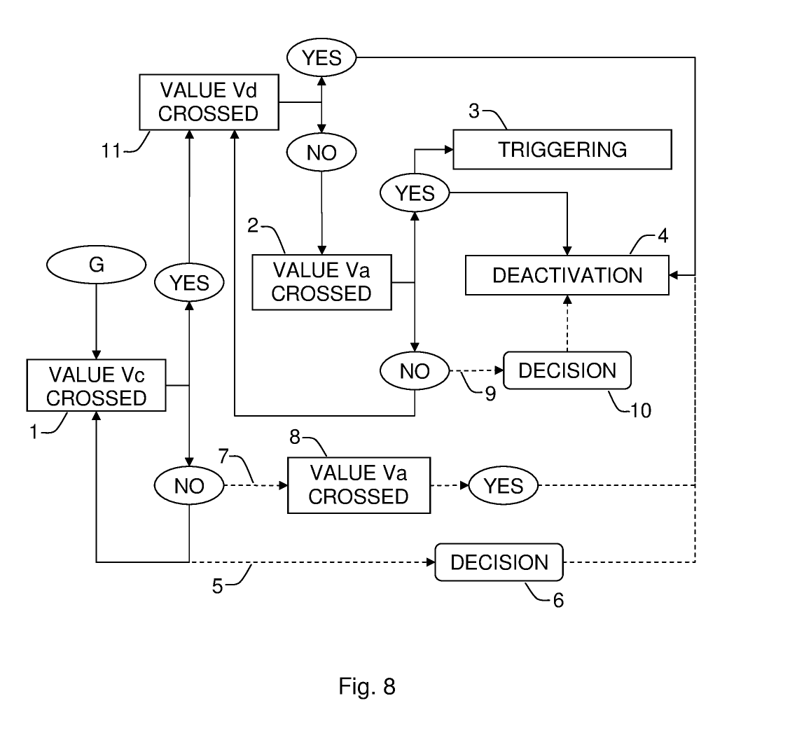

The previous (additional) feature is illustrated in the form of a functional diagram in FIG. 8. Value Vd, used by the processing device to deactivate the trend reversal alert in the case of the crossing of the said value, appears in the diagram in the form of an additional branch in the diagram in FIG. 5. Thus, the crossing of value Vc, following the comparison of value V with value Vc in step 1, is not immediately followed by step 2, but goes through the comparison of value V at the following (or identical) instant with value Vd in step 11. If value V crosses value Vd, that is, if (V−Vd)*(Vd−V0)≥0 (condition D), then, the processing device goes to step 4 to deactivate the trend reversal alert. If value V does not cross value Vd in step 11, then, the processing device goes to step 2. If value V does not cross value Va, then, the processing device goes back to step 11 (end of the additional branch). The rest remains unchanged. The arrows and the steps that remain unchanged, and not mentioned in the present paragraph, are numbered the same as in the diagram in FIG. 5. We will therefore refer to FIG. 5 to understand the rest (unchanged) of the diagram in FIG. 8.

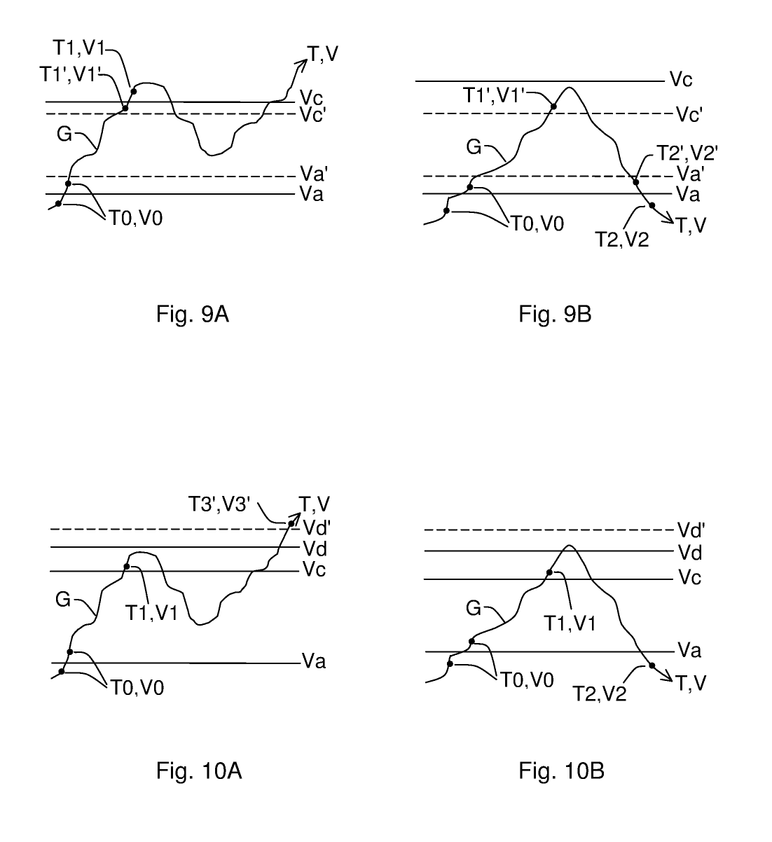

The processing means allow, thanks to a (additional) feature, modifying crossing value Vc, Va or Vd, as long as it has not been crossed. FIGS. 9A and 9B can be understood with the help of FIGS. 3A and 3B. The crossing value Vc (represented by a solid horizontal line) can be modified into a value Vc′ (represented by a dashed horizontal line) different from the value Vc, as long as value Vc has not been crossed. In FIG. 9A, the modifying of value Vc into a new value Vc′ led to its crossing at instant T1′ of corresponding value V1′ anterior (or equal) to instant T1 of corresponding value V1, instant of the crossing of value Vc by value V, if value Vc had not been modified. In the example presented in this figure, value Va has also been modified into a different value Va′, but value V has not (or not yet) crossed new value Va′, and therefore, alert A has not (or not yet) been triggered.

An example is represented in FIG. 9B, in which, without the modifying of value Vc, alert A would not have been triggered because the crossing of initial value Vc by value V, first step of algorithm 1, would not have taken place. The modifying of value Va into a new value Va′ led to a early triggering of alert A because the crossing instant T2′ of corresponding value V2′ is anterior (or equal) to instant T2 of corresponding value V2, instant of the crossing of value Va by value V if value Va had not been modified. These two examples illustrate how it is possible to modify the threshold values Vc and Va after initial instant T0. The condition which allows the authorized values for Vc, as long as Vc has not yet been crossed (that is, (V−Vc)*(Vc−V0)<0), is (V−Vc)*(V−Vc′)>0 (condition 3). The condition which allows authorized values for Va′, as long as Va not yet been crossed (that is, (Va−V)*(Vc−V0)<0), is (V−Va)*(V−Va′)>0 (condition 4).

Conditions 3 and 4 of the (additional) feature illustrated by FIGS. 9A and 9B can be realized, for example, in one of the forms listed below. The processing means of the alerting device:
forbid the user U from modifying value Vc into a new value Vc′, as long as value Vc has not been crossed, if value Vc′ does not meet condition 3;
forbid the user U from modifying value Va into a new value Va′, as long as value Va has not been crossed, if value Va′ does not meet condition 4;
warn the user U that such chosen new value Vc′ or Vd′ is forbidden by applying condition 3 or condition 4, respectively.

FIGS. 10A and 10B show two examples of trend reversal alerts where value Vd has been modified into a different value Vd′. In the example of FIG. 10A, the trend reversal alert has been deactivated because value Vd′ was crossed by value V at instant T3′ of corresponding value V3′. Note that the crossing of value Vd′ has been preceded by the crossing of value Vc at instant T1 of corresponding value V1. Value Vd′ cannot be crossed before value Vc (or Vc′ if value Vc was modified) because value Vd′ must meet condition 2, that is, in the present case (Vd′−Vc)*(Vc−Va)>0.

FIG. 10B shows an example of a trend reversal alert where alert A was triggered since value Va was crossed by value V at instant T2 of corresponding value V2. In this example, the trend reversal alert has not been deactivated because value Vd′ has not been crossed, unlike the old value Vd which would have been crossed if it had not been modified. Note that alert A would have been deactivated if value Vd had been modified into a value Vd′, present in the diagram below value Vd. The condition which determines authorized values for Vd′, as long as value Vd has not yet been crossed (that is, (V−Vd)*(Vd−V0)<0), is (V−Vd)*(V−Vd′)>0 (condition 5).

Condition 5 of the (additional) feature, illustrated in FIGS. 10A and 10B, can be realized, for example, in one of the forms listed below. The processing means of the alerting device:
forbid the user U from modifying value Vd into a new value Vd′, as long as value Vd has not been crossed, if value Vd′ does not meet condition 5;
warn the user U that such new chosen value Vd′ is forbidden by applying condition 5.

The alerting device also proposes processing means allowing graphical management of values Vc, Va and Vd thanks to lines, for example, horizontal, representing the said values, displayed, for example, on the output device CM. These graphical management means allow, thanks to lines, with the help of, for example, a mouse or computer keyboard:
inputting values Vc, Va and (optionally) Vd;
modifying values Vc, Va and Vd into new values Vc′, Va′ and Vd′, respectively;
forbidding certain values for Vc, Va and Vd, by limiting the authorized positions of each line associated to each said value (by applying conditions 1 and 2);
forbidding certain values for Vc′, Va′ and Vd′, by limiting the authorized positions of each line associated to each of these values when modifying any of values Vc, Va and Vd, respectively (by applying conditions 3 and 5);

A preferred embodiment for inputting thresholds Vc, Va and Vd consists in, for any of these thresholds, clicking on the chart on which quantity G is represented or in the margin of said chart on the value scale at the chosen location (ordinate), or clicking and dragging to the chosen location. A box associated to each line, in which the value corresponding to the ordinate of the line is displayed in real-time, allows the user U through feedback to input value Vc, Va or Vd. The keyboard can also be used to position precisely each of these lines, which we will call, to keep it simple, lines Vc, Va and Vd, respectively.

### Examples

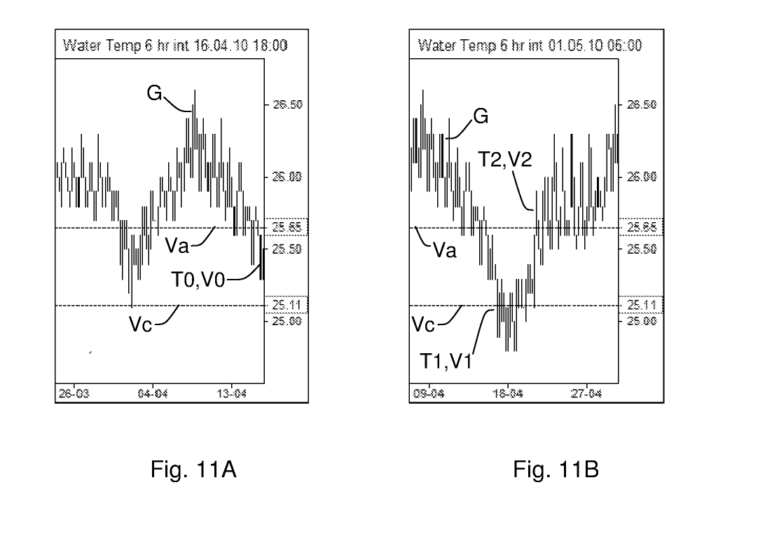

To illustrate what is written above, we will refer to FIGS. 11A and 11B whose charts represent the water temperature every 6 hours (weather series: Water Temperature, National Ocean Service Station 1612340, Honolulu, latitude 21° 18.4′ N, longitude 157° 52.0′ W, 2010).

FIG. 11A shows a chart at instant T0 after values Vc and Va have been input. Values Vc and Va have been chosen with the help of a topological network as mentioned at the beginning of the description, but other methods can be used.

FIG. 11B shows the chart an instant T posterior to the triggering of the alert A. One can see on FIG. 11B that values Vc and Va have been crossed at past instants T1 and T2, respectively. On 11A and 11B, boxes associated to lines Vc and Va are present in the margins of the charts. The modifying of values Vc and Va can be performed, for example, by clicking and dragging the said boxes (only in the example of FIG. 11A because, in the example of FIG. 11B, the thresholds Vc and Va have already been crossed).

To allow easy identification of lines Vc, Va and Vd, different colors and/or dashed lines of various appearance, such as in FIGS. 11A and 11B, can be used.

The processing means also allow the use of a quantity G, for which each event comprises an instant, a primary value and a secondary value. When the secondary value is a weight (or weighting coefficient), the processing means use for value V the primary value and ignore the secondary value. When the secondary value is not a weight, the primary and secondary values are both used by the processing means. When the primary and secondary values of instant T represent the maximum and minimum values reached by quantity G between instant T and the previous instant (or between instant T and the following instant, depending on how T has been defined to represent quantity G numerically), the processing means ensure that the comparison of value V with thresholds Vc, Va or Vd is done with one of the two, primary or secondary, values that crosses the said threshold first. For example, if the threshold is “above” value V, it is the maximum value that is used as value V for performing the comparisons with the said threshold. When the primary and secondary values of instant T represent the average value M and the dispersion D assumed by quantity G between instant T and the previous instant (or between instant T and the following instant), the processing means ensure that the comparison of value V with thresholds Vc, Va or Vd is performed with one of the two values, M+D or M−D, that crosses the said threshold first. For example, if the threshold is present “above” value V, it is value M+D that is used as value V for performing the comparisons with the said threshold.

The example present in FIGS. 11A and 11B corresponds to a quantity G for which each event comprises a primary value M, and a secondary value D (dispersion) and an instant. In the case of the threshold Vc, it is value M−D that was used as value V, whereas, in the case of threshold Va, it is M+D that was used as value V. Note that if the events had been comprised of a primary maximum value H, and a secondary minimum value L, and an instant, the processing means would have performed the elementary operation M=(H+L)/2 and D=(H−L)/2.

The alerting device can comprise memorization means capable of storing values V1, V2 and V3 of the crossing of the respective thresholds Vc, Va and Vd by quantity G, their respective instants T1, T2 and T3, and the said thresholds. After triggering of the alert A, the processing module PM can request all the values stored in memory MM so as to present them (to the user) on the output device CM.

The alerting device, in a preferred embodiment, given as a non-limiting example, uses the Internet, a data server and a computer (such as a personal computer) equipped with a monitor, a keyboard and a mouse. The steps listed in the description are realized in the form of a software. The software comprises a data processing part and a graphical display management part.

### SUMMARY OF INVENTION

The invention can be summarized by at least some of the characteristics that it comprises listed below:
algorithm 1 consists in comparing value V of a considered quantity with a chosen value Vc, and if value V does not cross value Vc, starting over and comparing value V assumed at the following instant with value Vc, and if value V crosses value Vc (which can be expressed, for example, by (V−Vc)*(Vc−V0)≥0 (condition C)), comparing value V assumed at the following instant with a chosen value Va, and if value V does not cross value Va, starting over and comparing value V assumed at the following instant with value Va, and if value V crosses value Va (which can be expressed, for example, by (Va−V)*(Vc−V0)≥0 (condition A)), triggering an alert;
the alerting device ensures that values Vc and Va are chosen in such a way that they are not identical, that they are different from initial value V0, and that values V0 and Va are “on the same side” in relation to value Vc (which can be expressed, for example, by (Vc−V0)*(Vc−Va)>0 (condition 1));
the alerting device ensures that, when a value Vd is chosen, value Vc must be between values Va and Vd (which can be expressed, for example, by (Vd−Vc)*(Vc−Va)>0 (condition 2));
the trend reversal alert is deactivated if value V crosses value Vd at a posterior (or equal) instant to the instant of the crossing of value Vc by value V (which can be expressed, for example, by (V−Vd)*(Vd−V0)≥0 (condition D));
the alerting device allows modifying each of the crossing values Vc, Va and Vd, as long as each of these values has not been crossed, and authorizes new values Vc′, Va′ and Vd′ if (V−Vc)*(V−Vc′)>0 (condition 3), if (V−Va)*(V−Va′)>0 (condition 4) and if (V−Vd)*(V−Vd′)>0 (condition 5), respectively;
the alerting device allows deactivation of the trend reversal alert if value Va was crossed before value Vc was crossed, which is possible only if chosen values Vc and Va are such that value V0 is between values Vc and Va (which can be expressed, for example, by (V0−Va)*(Vc−Va)>0 (condition 6));
the alerting device comprises graphical management means, capable of managing values Vc, Va and Vd thanks to lines (for example, horizontal) representing the said values and displayed, for example, on a computer monitor, allowing inputting, modifying and forbidding the said values;
the alerting device comprises memorization means capable of storing values V1, V2 and V3 of the crossing of the respective thresholds Vc, Va and Vd by quantity G, their respective instants T1, T2 and T3, and the said thresholds.

The present invention allows warning of a trend reversal to come in the evolution of a quantity in numerous technical fields, such as meteorology, economy, financial markets, seismology, and population dynamics. Other than this possibility, it can be realized in the form of software and requires very little computing power compared to other approaches based on computerized mathematical models. It can be used also to place stock market orders, in which case, the alert results in buying or selling. It proposes also a graphical management of the trend reversal alert. The invention is not limited to the embodiments of the data processing device, storage medium, and computer system described hereinbefore, given only by way of example, but encompasses all the variants that may be envisaged by the man skilled in the art within the scope of the claims that follow.

1. Alerting device for anticipating trend reversal in real-time capable of processing numerical data events from a quantity varying over time, each event comprising at least a primary value assumed at a given instant and the said instant, characterized in that it comprises processing means arranged so as to, provided that the initial value V0 and the chosen threshold values Vc and Va are all different and such that (Vc−V0)*(Vc−Va) is strictly positive, compare, starting from the initial instant T0 corresponding to value V0, value V of the said quantity with value Vc, and if value V does not cross value Vc, start over and compare value V assumed at the following instant with value Vc, and if value V crosses value Vc, compare value V assumed at the following instant with value Va, and if value V does not cross value Va, start over and compare value V assumed at the following instant with value Va, and if value V crosses value Va, trigger an alert.

2. Device according to claim 1, characterized in that the processing means deactivate the alert if value Va is crossed before value Vc has been crossed.

3. Device according to claim 1, characterized in that the processing means deactivate the alert if value V crosses chosen threshold value Vd at an instant posterior or equal to the crossing of value Vc by value V.

4. Device according to one of claims 1 to 3, characterized in that the processing means, when each event comprises a primary value and a secondary value, use for value V the primary value or the secondary value or use for value V the sum or the difference of the primary and secondary values.

5. Device according to one of claims 1 to 4, characterized in that the processing means deactivate the trend reversal alert when the alert is triggered.

6. Device according to one of claims 1 to 5, characterized in that the processing means deactivate the trend reversal alert if the alert has not been triggered before a chosen instant posterior to initial instant T0.

7. Device according to one of claims 1 to 6, characterized in that the processing means allow modifying values Vc, Va or Vd into new values Vc′, Va′ or Vd′, respectively.

8. Device according to one of claims 1 to 7, characterized in that values Vc, Va, Vd, Vc′, Va′, and Vd′ are represented by horizontal lines on a output device.

9. Device according to one of claims 1 to 8, characterized in that a mouse is used to move the horizontal lines representing Vc, Va, Vd, Vc′, Va′, and Vd′.

10. Device according to claim 1, characterized in that the triggering of the alert is accompanied by a visual or sound warning.

11. Device according to claim 1, characterized in that the triggering of the alert is accompanied by an action.

12. Device according to claim 11, characterized in that the action is a buying or selling order for a financial instrument.

13. Device according to one of claims 1 to 12, characterized in that memorization means are capable of storing the values V1, V2 and V3 of the crossing of the respective thresholds Vc, Va and Vd by the said quantity, their respective instants T1, T2 and T3, and the said thresholds.

14. Storage medium for data files defining programs for a computer system, characterized in that it stores at least part of an alerting device according to one of the preceding claims, arranged in the form of programs.
